(19) United States
(12) Patent Application Publication
(10) Pub. No.: US 2005/0083019 A1
(43) Pub. Date: Apr. 21, 2005

(54) Device for the inductive transfer of electrical energy

(75) Inventor: Andrew Green, Malsburg-Marzell (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(73) Assignee: WAMPFLER AKTIENGESELLSCHAFT, WEIL AM RHEIN-MARKT (DE)

(21) Appl. No.: 10/952,560

(22) Filed: Sep. 27, 2004

Related U.S. Application Data
(63) Continuation of application No. PCT/EP03/01099, filed on Feb. 5, 2003.

(30) Foreign Application Priority Data
Apr. 6, 2002 (DE) 102 15 236.5

(51) Int. Cl. H02J 7/00

(52) U.S. Cl. 320/137; 320/138; 323/355; 340/10.34

(57) ABSTRACT

Device for the inductive transfer of electrical energy to a movable consumer with a secondary inductance that is movable relative to the location-fixed primary inductance wherein a rectifier and a switching regulator are connected downstream of this secondary inductance in order to produce a first DC voltage of predetermined magnitude. An arrangement is included for the production of at least one additional DC voltage, characterized by the features that the outlet of the switching regulator is constructed in the form of a capacitive voltage divider in order to produce the additional DC voltage U_{L2}, where the overall voltage of the outlet is the first DC voltage U_{L} and the additional DC voltage U_{L2} is available at a first tapping off point, and that the first tapping off point of the voltage divider is connected, via a diode, to a second tapping off point of the secondary inductance of the same subdivision ratio, with the anode of the diode hooked up to the tapping off point.

### RELATED APPLICATION

This application is a continuation of International Application No. PCT/EP03/01099 filed Feb. 5, 2003, the contents of which are here incorporated by reference in their entirety. Applicant claims the benefit of 35 USC Section 120.

### BACKGROUND OF THE INVENTION

1. Field of the Invention

The invention pertains to a device for the inductive transfer of electrical energy.

2. Prior Art

Such a device serves for the transfer of electrical energy to a movable consumer without any mechanical or electrical contact. It comprises a primary and a secondary part that are electromagnetically coupled in a way that resembles the principle of a transformer. The primary part comprises a feed electronic system and a conductive loop that is installed along a certain stretch. One or more consumers and the associated consumer electronic systems form the secondary side. In contrast to the transformer, in the case of which the primary and the secondary parts are coupled as closely as possible, one is dealing here with a loosely coupled system. This is possible as a result of a relatively high operating frequency in the kiloHertz range. In this way, even large air gaps of up to several centimeters can be bridged. The operating frequency on the secondary side is hereby arranged to be the resonance frequency of a parallel oscillatory circuit that is formed by the parallel connection of a capacitor to the consumer coil.

Freedom from wear and from maintenance and safety with regard to touching and ready availability are included among the advantages of this type of energy supply system. Typical applications are automatic material transportation systems in manufacturing technology, and also personal transportation systems such as elevators and electrically driven buses.

A basic circuit diagram of the consumer side is described in WO 92/17929, and is illustrated in simplified form in FIG. 1. A rectifier 1 is connected downstream of the consumer inductance L1 and the capacitor C1 that is connected in parallel thereto in order to form an oscillatory circuit, and a switching regulator of known type comprising an inductance L2, a diode D1, a capacitor C2, and an electronic switch S as well as a regulator 2 are hooked up to the rectifier. The regulator 2 comprises, in essence, a voltage reference and a comparator, which closes the electronic switch S via the control line 3 when the voltage across the capacitor C2 exceeds a first predetermined value, and opens it [the electronic switch] when it [the voltage] falls below a second value that is only a little below the first [value], as a result of which the voltage U_{L} across the capacitor C2 and the load 4, which is hooked up in parallel thereto at the terminals A and B, approximately adopts a predetermined target value. The load 4 is typically an electrical drive system.

In many applications, a control electronic system has to be supplied with electricity in addition to the main load 4 in the form of an electrical drive unit, wherein the necessary voltage levels differ considerably. Whereas a typical value for the voltage for the supply of electricity to the drive unit amounts to approximately 560 V, the voltages in the control electronics region are more than one order of magnitude lower, e.g. 24 V. A possible route for the provision of a second, significantly lower output voltage is to connect a DC transformer to the terminals A and B in parallel to the main load 4. Such DC transformers that are being spoken of here for the conversion ratio of, e.g. 560 V to 24 V are, however, expensive [to manufacture] and are therefore costly.

Another route is proposed in DE 100 14 954 A1 that forms the basis of the preamble of Claim 1. A second secondary coil is provided on the consumer core in order to obtain a second, significantly lower DC voltage, and this secondary coil is connected to a second rectifier. Although this is not mentioned in the quoted specification, a second regulator will probably have to be connected downstream of the second rectifier in order to stabilize the voltage, as a result of which the consumer electronics system is effectively duplicated at the low voltage level. The necessity of applying a second secondary coil on the consumer [side] also limits design freedom in the construction of the consumer [side].

A high voltage generator for the production of a high voltage in the kilovolt range for the anode of a cathode ray tube is known from U.S. Pat. No. 6,005,435 in which an RC parallel component, which is needed on the output side for subdividing the output voltage in the form of a regulatory parameter with a high flank steepness, is formed by means of the serial connection of two individual RC parallel components. As a result of this, less stringent requirements arise for the electric strength of the capacitors that are used as well as a more compact assembly of the circuit.

DE 38 32 442 A1 teaches a device for the supply of electric current for a traveling towing car in which an alternating voltage, which is tapped off from the heavy duty towing and electrical connecting cable, is rectified and transformed into an intermediate circuit DC voltage of 600 V by a low voltage converter. 3×380 V sinusoidal alternating voltages are produced from this by means of two identical alternating current inverse rectifiers and LC filters that are connected downstream thereof. The low voltage converter hereby comprises two serially connected GTO thyristors that are connected on the input side and the output side via two identical capacitances that are connected to one another in series and whose connecting points are connected to one another. This circuit configuration for the low voltage converter serves for doubling its input electric strength.

### SUMMARY OF THE INVENTION

Proceeding on the basis of this prior art, the problem for the invention comprises the indication of a route, which is as simple as possible, for making available at least one second output voltage in the case of a device of this general type with only slight incursions into the consumer system on the secondary side.

This problem is solved by a device with the features that are indicated in Claim 1. Advantageous further developments of the invention can be seen in the dependent claims.

A significant advantage of the invention resides in the aspect that only a few additional construction elements are needed and no great change in the circuit topology is required in order to obtain an additional output voltage. The incursion into the consumer [system] itself is minimal because it is limited to one tapping off point of the secondary coil. The efficiency of energy transfer also experiences no noteworthy impairment as a result of the modification of the consumer electronics. The subdivision of the capacitances into serial circuits, which is necessary in order to realize the invention, has the positive side effect that a lower voltage drop occurs across each individual capacitance, whereby this signifies less stringent requirements in terms of the electric strength of the capacitors that are used.

As an additional special advantage, the invention permits the use of a DC transformer with an input voltage of less than 300 V for supplying the control electronics. Such DC transformers are used in large numbers in items of apparatus that are driven by a mains supply voltage power supply, and they are therefore obtainable inexpensively.

An especially preferred, inexpensive, and compact solution is the realization of the device in accordance with the invention in one single construction element together with a converter serving to actuate a drive unit, wherein the concept of such a combination is also applicable to conventional devices of this general type.

### BRIEF DESCRIPTION OF THE DRAWINGS

Embodiments of the invention are described below by means of drawings. The following aspects are shown therein.

FIG. 1 shows a basic circuit diagram of a consumer electronics system in accordance with the prior art;

FIG. 2 shows a circuit diagram of a consumer electronics system in accordance with the invention with a second output voltage;

FIG. 3 shows the hooking up of a consumer electronics system in accordance with the invention with a load in the form of a drive unit that is actuated by a converter.

### DETAILED DESCRIPTION OF PREFERRED EMBODIMENTS OF THE INVENTION

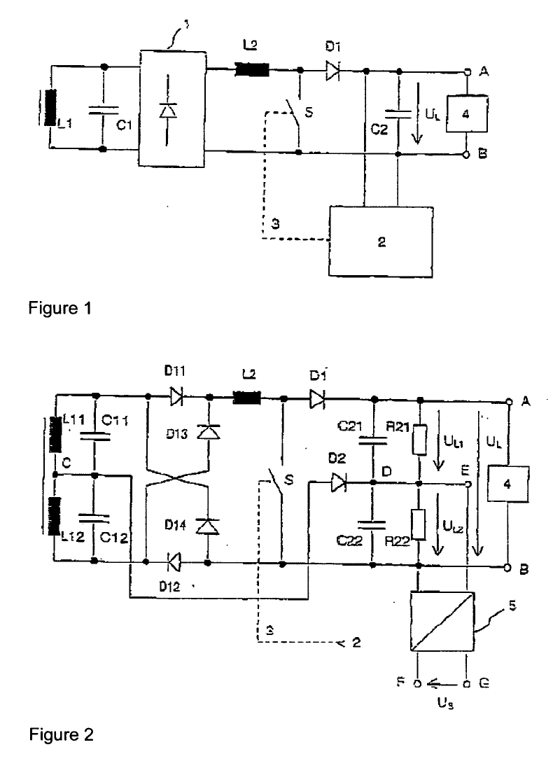

The embodiment of the invention that is illustrated in FIG. 2 aims at making available a second output voltage U_{L2} that is approximately half as large as the voltage U_{L} that is needed for the main load 4 and that is still provided in unchanged magnitude, e.g. 560 V, between the terminals A and B. Accordingly, the consumer inductance L1 is subdivided into two equally large inductances L11 and L12 that are connected to one another in series and whose sum corresponds to the inductance L1. This subdivision of the inductance L1 is realized by means of a middle tapping off point C of the coil without other changes to the coil or to the core.

In the same way, the capacitors C1 and C2 are subdivided into serial connections of two equally large capacitors C11 and C12 or C21 and C22, wherein, as is known, the partial capacitances each must have twice the value of the total capacitance. The connecting point of the capacitors C11 and C12 is connected to the middle tapping off point C of the consumer coil, i.e. to the connecting point of the inductances L11 and L12, i.e. these two connecting points form a communal junction C. This procedure does not change anything in regard to the characteristics of the consumer oscillating circuit in terms of its outer connections that are connected to the rectifier 1.

The four diodes D11 through D14, which are connected downstream of the consumer oscillatory circuit in FIG. 2, form the rectifier 1, which is illustrated only schematically in FIG. 1, in a known way. This part of the circuit does not experience any change. In the same way, the diode D1, the electronic switch S, and the regulator 2, which taps off the voltage U_{L} across the load 4 between the terminals A and B and holds this voltage U_{L} constant at a predetermined value as a result of suitable actuation of the switch S via the control line 3, remain unchanged. For the sake of clarity, the regulator 2 is no longer illustrated in FIG. 2.

Two equally large resistors R21 and R22, of relatively high ohmic value and in the form of additional elements, are connected in parallel to the capacitors C21 and C22 in the circuit in each case. In addition, the middle tapping off point C of the consumer [system] inductance, which is composed of L11 and L12, is connected via a diode D2 to the connecting point D of the capacitors C21 and C22 as well as the resistors R21 and R22, wherein the diode is connected such that it permits the flow of electric current only from C to D, i.e. from the consumer oscillatory circuit to the RC components on the output side.

The partial voltage U_{L2} across the parallel circuit comprising C22 and R22, which voltage is approximately equal to the partial voltage U_{L2} [sic; U_{L1}] across the parallel circuit comprising C21 and R21 and thus amounts to half of the output voltage U_{L} that is applied across the main load 4, is fed to the inlet of a DC transformer 5 that produces the output voltage U_{S} therefrom. The additional output terminal for connecting the transformer 5 is designated E in FIG. 2. Typical values for the designated voltages are U_{L1}=U_{L2}=280 V, and U_{S}=24 V.

The mode of functioning of the circuit proceeds, first of all, from the halving of the overall output voltage U_{L} as a result of subdividing the original output capacitor C2 into 2 mutually serially connected and equally large capacitors C21 and C22. However, it is not possible simply to connect a DC transformer to an appropriate low nominal input voltage across one of the capacitors C21 or C22 in order to produce a low voltage U_{S}, which is required in addition to U_{L}, since the load asymmetry that is caused as a result of this would allow the voltage across the capacitance in question to break down.

In order to avoid this, the invention provides for the feature that the consumer inductance L1 and the tuning capacitor C1, which is connected in parallel thereto, are appropriately subdivided into partial inductances L11 and L12 and [partial capacitors] C11 and C12, and the junction C, at which the two partial oscillatory circuits that are produced as a result are connected together, are connected to the connecting junction D of the two output capacitances. The breakdown of the voltage across the capacitor C22, which is provided in the present case for tapping off the partial voltage for the additional DC/DC transformer 5, can be avoided as a result of this measure, but a short circuit on the pathway via the partial inductance L12, the rectifier diode D13, the inductance L2, and the switch S would arise in the closed state of the switch S for the DC voltage across C22. The task for the additional diode D2 is to prevent the discharge of the capacitor C22 via this short circuit pathway.

The circuit already functions satisfactorily solely with the measures that are described above, i.e. one half of the voltage that is applied between the terminals A and B can additionally be tapped off across C22 and supplied to a DC/DC transformer 5. However, if, for whatever reason, the main load 4 is separated from the consumer electronics system, then constancy of the voltage U_{L2} would no longer be ensured since, in this case, the only remaining ohmic load would be connected in parallel to C22, whereas the regulator 2, as shown in FIG. 1, observes the overall voltage U_{L}=U_{L1}+U_{L2}.

In order to ensure a stable partial voltage U_{L2} even in the case of separation of the main load 4, the two equally large resistors R21 and R22 are each connected in parallel to the capacitors C21 and C22, as a result of which the presence of an ohmic load between the terminals A and B is ensured. This load is not symmetrical in overall terms, wherein the extent of the asymmetry depends primarily on the magnitude of the power that is tapped off at the terminals F and G of the DC/DC transformer 5. This means that the power, which is capable of being tapped off from these terminals, is limited especially in the case of operating the consumer electronics system without a hooked up main load 4. As already mentioned at the beginning, the additional voltage U_{S} is needed only for operating a control electronics system that has only a low demand for power in comparison to the main load 4. The additional resistors R21 and R22 can have a relatively high ohmic value, i.e. on the order of 10-100 kΩ.

Although the embodiment described in the preceding section provides for the symmetrical subdivision of the consumer oscillatory circuit and of the RC components on the output side, it would also be possible to select an asymmetrical subdivision ratio in order to be able to tap off an additional voltage that is greater than or smaller than one half of the output voltage U_{L}.

It would also basically be conceivable to undertake subdivision into more than two voltages in the event that several different additional voltages were needed. Such modifications or expansions are easily accessible to the technical expert, who is skilled in the art, with knowledge of the example that is described above, and they are a component of the present invention.

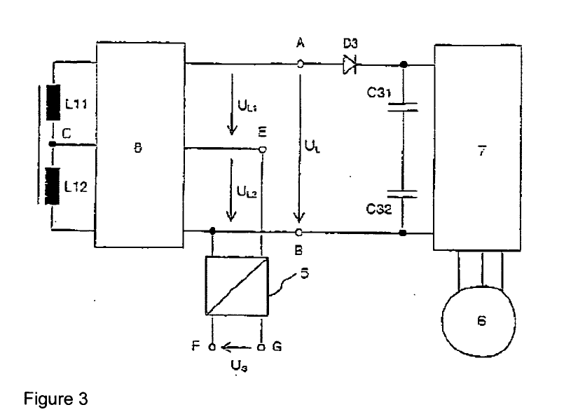

FIG. 3 shows an expedient form of interconnection of the consumer electronics system, which is described above, with a main load 4 in the form of a nonsynchronous motor 6 that is actuated by a three phase converter 7. The consumer electronics system is illustrated in FIG. 3 in the form of a block 8 that is to contain all the components of the circuit, which is elucidated by means of FIG. 2, with the exception of the consumer inductance L11+L12, the DC transformer 5, and the main load 4. The configuration that is shown in FIG. 3 with a motor 6, which is actuated by a converter 7, is a typical form of main load 4 that is provided for connection to the terminals A and B of a consumer electronics system 8 in accordance with the invention.

The problem that arises hereby is that in the event of generator operation of the motor 6, such as occurs during a braking procedure, power can flow back via the converter 7 in the direction of the consumer electronics system 8. In the case of a consumer electronics system in accordance with the prior art, as shown in FIG. 1, this would lead to an increase in voltage across the output capacitor C2, which would cause the regulator 2 to close the switch S in order that no contribution be made to any further increase in output voltage U_{L} from the side of the consumer. The voltage increase would not be disruptive as long as the regulator 2 can cope with it.

In the case of a circuit in accordance with the invention as shown in FIG. 2, however, no such increase in the output voltage U_{L}=U_{L1}+U_{L2} can be permitted in the event of generator operation of the motor 6 since it would ruin the stability of the input voltage U_{L2} of the DC transformer 5. A marked increase in the output voltage could even lead to damage of the inlet of the DC transformer 5 as a result of the corresponding marked increase in the partial voltage U_{L2}.

For this reason, the interconnection in FIG. 3 of an additional diode D3 between the output terminal A of the consumer electronics system 8 and the converter 7, as well as the parallel connection of an additional capacitance, which comprises two capacitors C31 and C32 in series with one another, is provided in parallel to the inlet of the converter 7. An increase in voltage at the inlet of the converter 7 as a consequence of operating the motor 6 in the braking mode leads, in this case, to the charging up of the capacitors C31 and C32, whereas a reverse current to the outlet of the consumer electronics system 8, which reverse current would increase the voltage there with accompanying charging up of the capacitors C21 and C22 on the output side, is prevented by the diode D3. The capacitors C31 and C32 are needed for accommodating the energy that flows back from the converter 7, wherein the subdivision of the capacitance into two serially connected capacitors is not essential but is expedient for realizing [the invention] with capacitors with lower electrical strength.

It is especially expedient if the consumer electronics system 8, the converter 7, and the elements which are connected between them, namely the diode D3 and the capacitors C31 and C32 in the example of FIG. 3, are combined into one construction unit. This means that they are at least accommodated in one shared housing. In addition, they can also advantageously be arranged on one shared board. As a result of this, space, weight, and components are saved, and thus a more compact and less expensive solution is created in contrast to the prior art in which the consumer electronics system 8 and the converter 7 are separate units each with its own housing, whereby these first have to be connected to one another by means of a cable and plug.

This applies not only to the case in which the consumer electronics system 8 permits the tapping off of a second output voltage, but also to the combination of a conventional consumer electronic system as illustrated in FIG. 1 with a converter 7 that is provided for actuating a drive unit 6. The combination of the aforementioned system components to give one shared construction component always brings about the saving of space, weight and costs relative to the embodiment in the form of separate construction units. A special advantage arises in the case of a consumer electronics system 8 in accordance with FIG. 2 with two output voltages as a result of the fact that the additional elements D3, C31, and C32, which are needed in this case for de-coupling the consumer electronics system 8 from the converter 7 in the event of a reverse power flow, can be integrated into the shared construction unit without great expense.

1. Device for the inductive transfer of electrical energy to a movable consumer with a secondary inductance that is movable relative to the location-fixed primary inductance, where a rectifier and a switching regulator are connected downstream of this secondary inductance in order to produce a first DC voltage of predetermined magnitude, and with means for the production of at least one additional DC voltage, characterized by the feature that the outlet of the switching regulator is constructed in the form of a capacitive voltage divider in order to produce the additional DC voltage U_{L2}, where the overall voltage of the outlet is the first DC voltage U_{L} and the additional DC voltage U_{L2} is available at a first tapping off point, and by the feature that the first tapping off point of the voltage divider is connected, via a diode, to a second tapping off point of the secondary inductance of the same subdivision ratio, with the anode of the diode hooked up to the tapping off point.

2. Device in accordance with claim 1, characterized by the feature that a capacitance is connected in parallel to the secondary inductance with this capacitance formed by the serial connection of two capacitors, whose subdivision ratio coincides with that at the second tapping off point of the secondary inductance, and whose connecting point is connected to the tapping off point.

3. Device in accordance with claim 1, characterized by the feature that the capacitive voltage divider comprises two serially connected capacitors whose connecting point forms the first tapping off point.

4. Device in accordance with claim 3, characterized by the feature that the capacitive voltage divider also comprises two serially connected resistors whose values are in the same ratio to one another as the values for the capacitors, and by the feature that the connecting point of the two capacitors and that of the two resistors are connected to one another.

5. Device in accordance with claim 4, characterized by the feature that the resistors have such high ohmic values that the power that is transformed in them is negligibly small in comparison to the nominal power that is capable of being released at the outlet.

6. Device in accordance with claim 1, characterized by the feature that the additional DC voltage U_{L2} amounts to approximately half the overall voltage U_{L} at the outlet.

7. Device in accordance with claim 1, characterized by the feature that the overall voltage U_{L} at the outlet is on the order of 500-600 volts.

8. Device in accordance with claim 1, characterized by the feature that a DC transformer is hooked up to the first tapping off point of the voltage divider, which DC transformer reduces the additional DC voltage U_{L2} by approximately one order of magnitude.

9. Device in accordance with claim 8, characterized by the feature that the output voltage U_{S} of the DC transformer is on the order of 20-30 volts.

10. Device in accordance with claim 1, characterized by the feature that a load, which is hooked up to the outlet of a consumer electronics system that is connected to the secondary inductance, contains a suitable converter for supplying electrical power to an electrical drive unit.

11. Device in accordance with claim 10, characterized by the feature that the converter is connected to the outlet of the consumer electronics system via a diode whose anode is hooked up to an output terminal of the consumer electronics system.

12. Device in accordance with claim 11, characterized by the feature that a capacitance is connected in parallel to the inlet of the converter.

13. Device in accordance with claim 10, characterized by the feature that the converter is combined with the consumer electronics system to give one construction unit.

14. Device in accordance with claim 13, characterized by the feature that the converter and the consumer electronics system are arranged together on a shared circuit board.
